(19) United States
(12) Patent Application Publication
(10) Pub. No.: US 2013/0254230 A1
(43) Pub. Date: Sep. 26, 2013

(54) System for providing local search results

(71) Applicant: Tsang Chih KUO, Taoyuan County (TW)

(72) Inventor: Tsang Chih KUO, Taoyuan County (TW)

(21) Appl. No.: 13/752,593

(22) Filed: Jan. 29, 2013

(30) Foreign Application Priority Data
Mar. 26, 2012 (TW) 101205393

(51) Int. Cl. G06F 17/30

(52) U.S. Cl. CPC G06F 17/30545
USPC 707/770

(57) ABSTRACT

A system for providing local search results is provided with a setting module including fields including a keyword, a state, a county, a city, a mailing address, a location prominence, and a combination thereof; a database module for storing information of stores; a search algorithm module electrically connected to both the database module and the setting module for performing a search on the database module based on data input of the fields of the setting module and obtaining search results; and an information transmission module connected to a computer over the Internet and capable of sending the search results from the search algorithm module to the computer via the information transmission and over the Internet. The system can cover a narrow topic, resulting in a great reduction of both search time and the number of search results.

### BACKGROUND OF THE INVENTION

1. Field of the Invention

The invention relates to web search engines and more particularly to a system for providing local search results.

2. Description of Related Art

Typically, only one field for entering a query into Google's or Yahoo's search engine. Such informational queries may get millions of relevant results. For example, a query “automobile” may get 17,800,000 results, a query “printing” may get 64,500,000 results, and a query “3D” may get 731,000,000 results. However, a great number of search results can prolong the search time.

Further, a user may have difficulties of finding desired results from the search. A company may buy a keyword from a search engine provider (e.g., Google Inc.) for advertising its products or services. Alternatively, a company may pay advertisement fee to a search engine provider so as to increase visibility of its web site. However, the advertisement fee may be very high and it is not affordable to small and medium enterprises.

Above search is disadvantageous due to the following factors: Such queries cover a broad topic, resulting in a great number of search results (e.g., search engine results pages). A company being advertised on a search engine provider may appear repeatedly. Geographically constrained searches are not provided. Finally, many non-commercial advertisements may appear. Most persons cannot memorize nearby stores. It is difficult for persons finding a suitable store to buy his/her desired products or services. Local searches are not provided by the search engine providers. Thus, local stores may appear randomly and this is not desired. Further, specific locations of local stores are not available. To the contrary, a web visitor has to enter the store's web site to see the location information. It is reasonably for a buyer to buy products from a local store if prices of the products provided by the store are not greatly higher than other distal stores. This is further because after sales services are taken into account. In view of above, local searches may be more and more popular as time evolves. Moreover, the current keywords advertisement markets may be affected by the local search trend. However, the current local search methods, systems, and apparatuses are disadvantageous as far as the present inventor is aware. Thus, the need for improvement still exists.

### SUMMARY OF THE INVENTION

It is therefore one object of the invention to provide a system for providing local search results comprising a setting module comprising a plurality of fields including a keyword, a state, a county, a city, a mailing address, a location prominence, and a combination thereof; a database module for storing information of a plurality of stores; a search algorithm module electrically connected to both the database module and the setting module for performing a search on the database module based on data input of the fields of the setting module and obtaining search results; and an information transmission module connected to a computer over the Internet and capable of sending the search results from the search algorithm module to the computer via the information transmission and over the Internet.

The above and other objects, features and advantages of the invention will become apparent from the following detailed description taken with the accompanying drawings.

### BRIEF DESCRIPTION OF THE DRAWINGS

FIG. 1 is a block diagram of a system for providing local search results according to the invention.

### DETAILED DESCRIPTION OF THE INVENTION

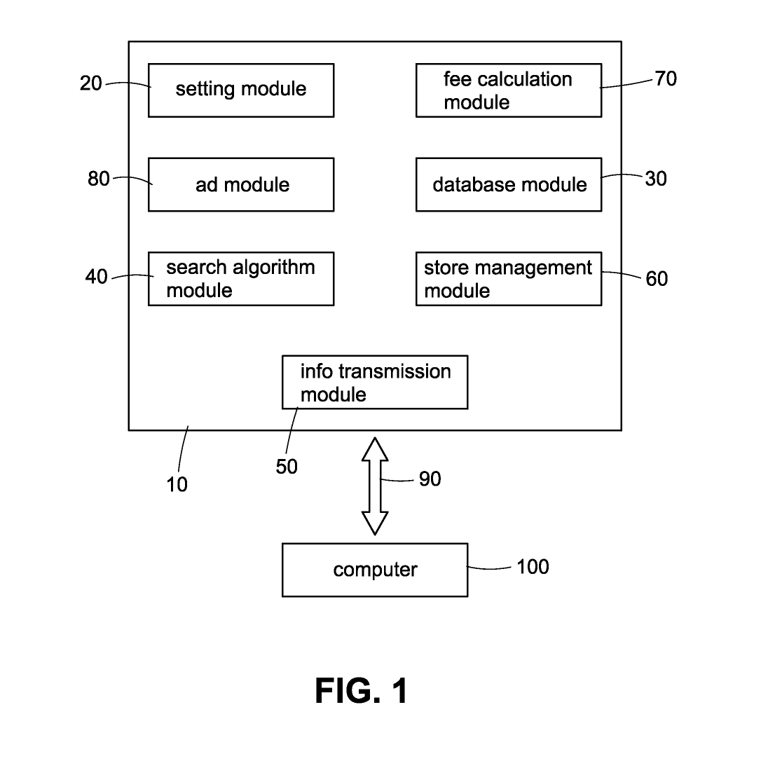

Referring to FIG. 1, a system for providing local search results in accordance with the invention comprises the following components as discussed in detail below.

A server 10 comprises a setting module 20, a database module 30, a search algorithm module 40, and an information transmission module 50 all electrically interconnected. The setting module 20 comprises a plurality of fields including a keyword, a state, a county, a city, a mailing address, a location prominence, and a combination thereof. The database module 30 is used to store information of stores. The search algorithm module 40 is electrically connected to both the database module 30 and the setting module 20. Further, the search algorithm module 40 performs a search on the database module 30 based on data input of the fields of the setting module 20. A user may use a computer 100 to connect to the information transmission module 50 over the Internet 90. Search results are obtained at the end of the search performed by the search algorithm module 40. The search results are sent from the search algorithm module 40 to the computer 100 via the information transmission 50 and over the Internet 90.

The user may use the computer 100 to connect to the server 10 over the Internet 90. Next, the user may enter keyword and detailed data including state, county, city, mailing address, and location prominence in order to cover a narrow topic. As a result, search time is greatly decreased and the number of search results is greatly decreased.

The setting module 20 provides a plurality of states, counties, and cities for user selecting one of each of them. For example, a selection of the state as California and then Orange, Santa Clara, etc. counties appear. Further, a selection of the county as Orange County and a plurality of cities in Orange County appear.

It is noted that the server 10 may further comprises a store management module 60 for respective stores managing its data stored in the database module 30, a fee calculation module 70 for charging management fee on the stores, and an advertisement module 80 for managing advertisements of the stores.

A search may be performed on the keyword, state, county, city, mailing address, location prominence, and a combination thereof entered in the setting module 20. For example, a keyword “communication” may be entered and next advanced search features (e.g., Boolean operator like AND, OR and NOT) may be provided, for example, for entering “Taipei” and “Zhongshan District”. As an end, all stores or companies related to communication and located in Zhongshan District of Taipei may appear on search engine results pages (SERPs). Further, a user may enter “Tatung District” after the “AND” operator. As an end, all stores or companies related to communication and located in Zhongshan and Tatung Districts of Taipei may appear on SERPs. Alternatively, a user may enter “communication” in the keyword field and next enter “Taipei” or “New Taipei City” or “Taoyuan”. As an end, all stores or companies related to communication and located in Taipei, New Taipei City and Taoyuan may appear on SERPs. This search is very precise.

Further, the keyword of the setting module 20 may be a string of characters, a telephone number, an email address, a facsimile number, a mailing address or a combination thereof.

Further, the database module 30 may store a plurality of store names, a contact name of each store, a telephone number of each store, a mailing address of each store, products and services provided by each store, and a web site of each store.

The information transmission module 50 may connect to the Internet 90 via infrared protocol, GSM protocol, GPRS protocol, WAP protocol, Bluetooth protocol, Wi-Fi protocol, WI-Max protocol, or IEEE protocol.

The database module 30 may employ SyBase database, DB2 database, Oracle database, Informix database, MS SQL database, PostgreSQL database, MySQL database, or mSQL database.

The search algorithm module 40 may be written by C language, C++ language, Java programming language, JavaScript programming language, PHP programming language, Python programming language, Ruby programming language, HTML programming language, or CSS programming language.

While the invention has been described in terms of preferred embodiments, those skilled in the art will recognize that the invention can be practiced with modifications within the spirit and scope of the appended claims.

What is claimed is:

1. A system for providing local search results comprising:
a setting module comprising a plurality of fields including a keyword, a state, a county, a city, a mailing address, a location prominence, and a combination thereof;
a database module for storing information of a plurality of stores;
a search algorithm module electrically connected to both the database module and the setting module for performing a search on the database module based on data input of the fields of the setting module and obtaining search results; and
an information transmission module connected to a computer over the Internet and capable of sending the search results from the search algorithm module to the computer via the information transmission and over the Internet.

2. The system of claim 1, wherein the information transmission module is connected to the Internet via infrared protocol, GSM protocol, GPRS protocol, WAP protocol, Bluetooth protocol, Wi-Fi protocol, WIMax protocol, or IEEE protocol.

3. The system of claim 1, wherein the database module employs SyBase database, DB2 database, Oracle database, Informix database, MS SQL database, PostgreSQL database, MySQL database, or mSQL database.

4. The system of claim 1, wherein the search algorithm module is written by C language, C++ language, Java programming language, JavaScript programming language, PHP programming language, Python programming language, Ruby programming language, HTML programming language, or CSS programming language.

5. The system of claim 1, wherein the setting module provides a plurality of states, counties, and cities for selecting one of each of the states, the counties, and the cities.

6. The system of claim 1, wherein the database module stores a plurality of store names, a contact name of each store, a telephone number of each store, a mailing address of each store, products and services provided by each store, and a web site of each store.

7. The system of claim 6, further comprising a store management module for each of the respective stores managing its data stored in the database module.

8. The system of claim 1, further comprising a fee calculation module for charging management fee on the stores.

9. The system of claim 1, further comprising an advertisement module for managing advertisements of the stores.
